(19) United States
(12) Patent Application Publication
(10) Pub. No.: US 2015/0146883 A1
(43) Pub. Date: May 28, 2015

(54) RESPONSE-COMPENSATED MICROPHONE

(71) Applicant: Jefferson Audio Video Systems, Inc., LOUISVILLE, KY (US)

(72) Inventors: Gennady Palitsky, Brooklyn, NY (US); Mark Efim Naiditch, Louisville, KY (US); Andrew Ross Green, Louisville, KY (US)

(21) Appl. No.: 14/555,996

(22) Filed: Nov. 28, 2014

Related U.S. Application Data
(60) Provisional application No. 61/909,509, filed on Nov. 27, 2013.

(51) Int. Cl. H04R 3/00

(52) U.S. Cl. CPC H04R 3/005
USPC 381/92

(57) ABSTRACT

Systems and methods are disclosed for managing input to and output from a microphone, including adapting the microphone's response to changing polar response patterns among multiple microphone capsules, providing output via multi-colored lights to reflect the system state and operational characteristics, and sending various information to and from the microphone (such as carrying power to the microphone, digital and/or analog audio from the microphone, and data to and/or from the microphone) via a single cable.

### REFERENCE TO RELATED APPLICATION

This application claims priority to U.S. Provisional Application No. 61/909,509, filed Nov. 27, 2013, titled “Response-Compensated Microphone.” The disclosure in that application is incorporated herein by reference.

### FIELD

This disclosure relates to microphones, and more particularly to microphones switchable between sensitivity patterns, visually indicating information, and communicating data with other devices.

### BACKGROUND

Microphone manufacturing uses different approaches to create variable sensitivity patterns, but the common ways are to use a minimum of two audio-sensing elements. They could be a combination of pressure and gradient (e.g., omnidirectional and figure-eight) elements, two back-to-back cardio elements, or two or more omnidirectional elements, the outputs of which are connected via a time-delay algorithm. With certain microphones, one can set the sensitivity pattern locally on the microphone (for example, the Astatic 930VPL microphone, distributed by CAD Audio of Solon, Ohio) or remotely (for example Astatic 901VP microphone, also available from CAD Audio).

Some existing microphones attempt to use identical microphone capsules in order to create a proper polar pattern pickup. Unfortunately, manufacturing tolerances for microphone sensitivity often require adjustments before use. In some situations, existing techniques use manual microphone balancing. Unfortunately, such processes are susceptible to human error, challenged by the difficulty of containing a uniform acoustical field during sensitivity balancing, adjustments being rendered in a non-anechoic environment, and the time-consuming nature of the process.

### SUMMARY

A first aspect of this system relates to a microphone array capable of producing a repeatable, gain-smoothed output signal during polar pattern switching. The system achieves DSP-based frequency-response equalization during polar pattern switching. Another aspect is the ability to balance gain between microphone capsules during the production testing stage.

Still another aspect is the use of multi-color lights (e.g., LEDs) included in the microphone's housing and configured to provide status information, such as power status, mute status, failure mode, input level, recording status, microphone identification, system connection status, microphone sensitivity pattern, and the like using fixed colors, flashing or pulsing patterns, fading patterns, and/or progressions between two or more colors.

Still another aspect is the communication of information to and from the microphone using an RJ-45 connector. The CATS and higher cable in some embodiments carries power to the microphone, carries differential analog and/or digital audio output signals from the microphone to another device, and provides a bidirectional communication channel.

The system achieves the goal of frequency response equalization during microphone polar pattern switching. Another object of the system is to provide the ability to balance microphone capsules' gain during the production testing stage. Current microphone production testing is a manual process, where human error is the main error component. At least some microphones constructed according to the present disclosure overcome this problem by implementing software-defined, automatic channel gain equalization.

### BRIEF DESCRIPTION OF THE DRAWINGS

FIG. 1 is a schematic diagram of a first-order microphone array setup.

FIG. 2 is a collection of graphs of polar patterns and correlated frequency responses.

FIG. 3 is a schematic diagram of a first-order microphone array with controllable output equalizer.

FIG. 4 is a schematic diagram of a variable pattern microphone, configured for setup gain equalization.

FIG. 5 is a schematic diagram of an anechoic box microphone test setup.

FIG. 6 is a schematic diagram of a host and microphones system according to the present disclosure.

### DESCRIPTION

For the purpose of promoting an understanding of the principles of the present disclosure, reference will now be made to the embodiment illustrated in the drawings and specific language will be used to describe the same. It will, nevertheless, be understood that no limitation of the scope of the disclosure is thereby intended; any alterations and further modifications of the described or illustrated embodiments and any further applications of the principles of the disclosure as illustrated therein are contemplated as would normally occur to one skilled in the art to which the disclosure relates.

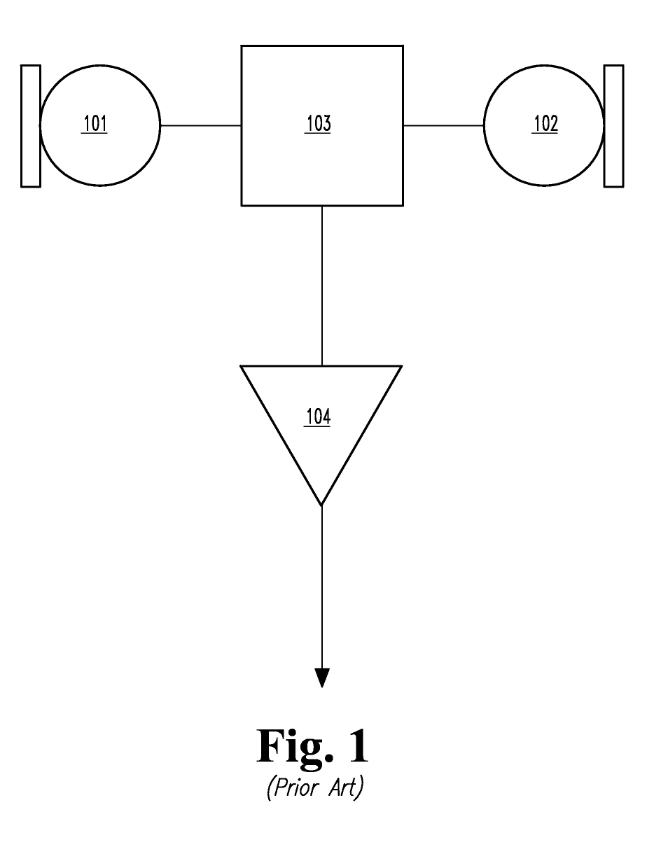

FIG. 1 illustrates a commonly used first-order microphone array setup. If microphone capsules 101 and 102 are cardioid picking pattern elements, then we can form different patterns by combining or subtracting signals from capsules 101 and 102 in mixer 103. Output buffer 104 provides sufficient output gain and an appropriate interface for the particular microphone application, as will be understood by those skilled in the art.

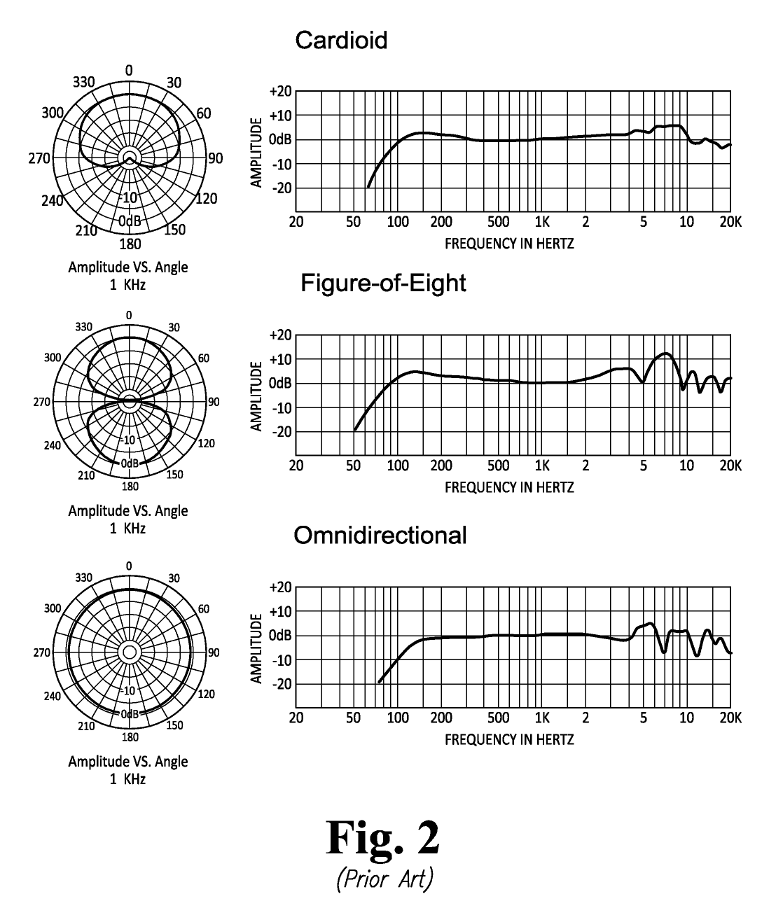

It has been observed that one common problem with the approach discussed above is inconsistent frequency response when different sensitivity patterns are applied. For example, Astatic 901VP microphones have frequency response patterns as shown in FIG. 2. This inconsistency can cause unintentional acoustical feedback and other undesirable audio results when microphone sensitivity patterns are changed.

FIG. 2 illustrates frequency response variations depending on the selected first-order polar pattern of an exemplary microphone. During pattern switching, output for some frequencies and locations can have significant variations between the gain resulting from the old pattern and that resulting from the new one. For example, if the polar pattern switches between the illustrated “Omnidirectional” and “Bidirectional” (figure-eight) patterns, output for a 7 KHz audio signal can change as much as 20 dB.

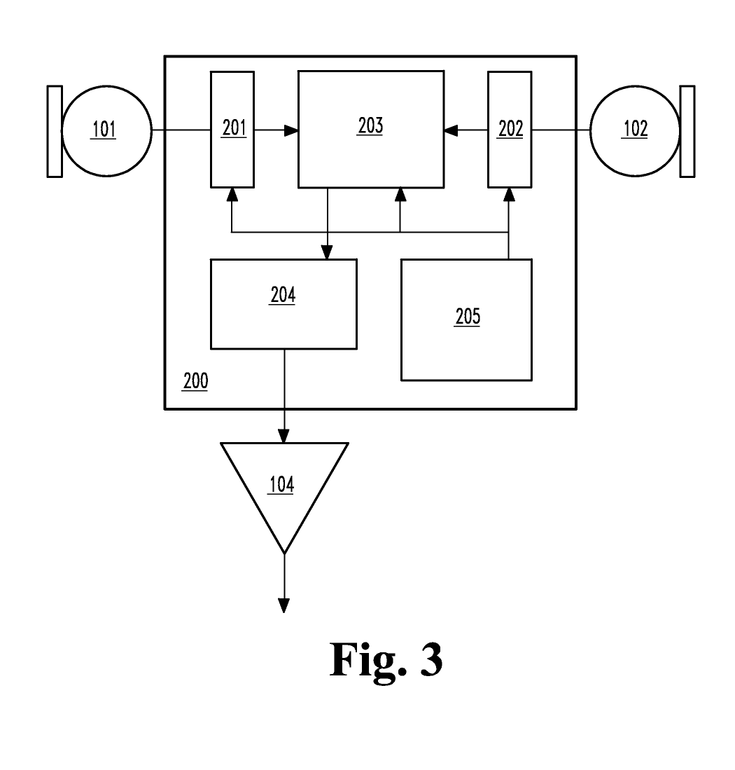

In order to minimize the effect of variations in frequency response, microphone system 200 includes an output equalizer 204, as illustrated in FIG. 3. Microcontroller 205 selects the polar-pattern pickup, controlling settings of mixer 203 and switching equalizer 204 as a function of the currently selected pattern and the previously selected pattern.

Individual level and/or frequency response parameters of microphone capsules 101 and 102 can be corrected by input equalizers 201 and 202, as illustrated in FIG. 3. If the frequency response of both capsules is within the limits required by the particular application, input equalizers 201 and 202 can be replaced by simple input amplifiers for capsule-level balancing.

Mixer 203, input equalizers/amplifiers 201 and 202, and output equalizer 204 are built in this exemplary embodiment on a digital signal processor (DSP). Other implementations will use alternative audio processing technology.

In this embodiment, level balancing and optional frequency response correction of microphone capsules 101 and 102 are executed only at a production setup stage as described below. During sensitivity pattern switching, only parameters of mixer 203 and output equalizer 204 are controlled by the microcontroller 205. In alternative embodiments, other parameters will be adjusted to achieve smooth transitions between sensitivity patterns.

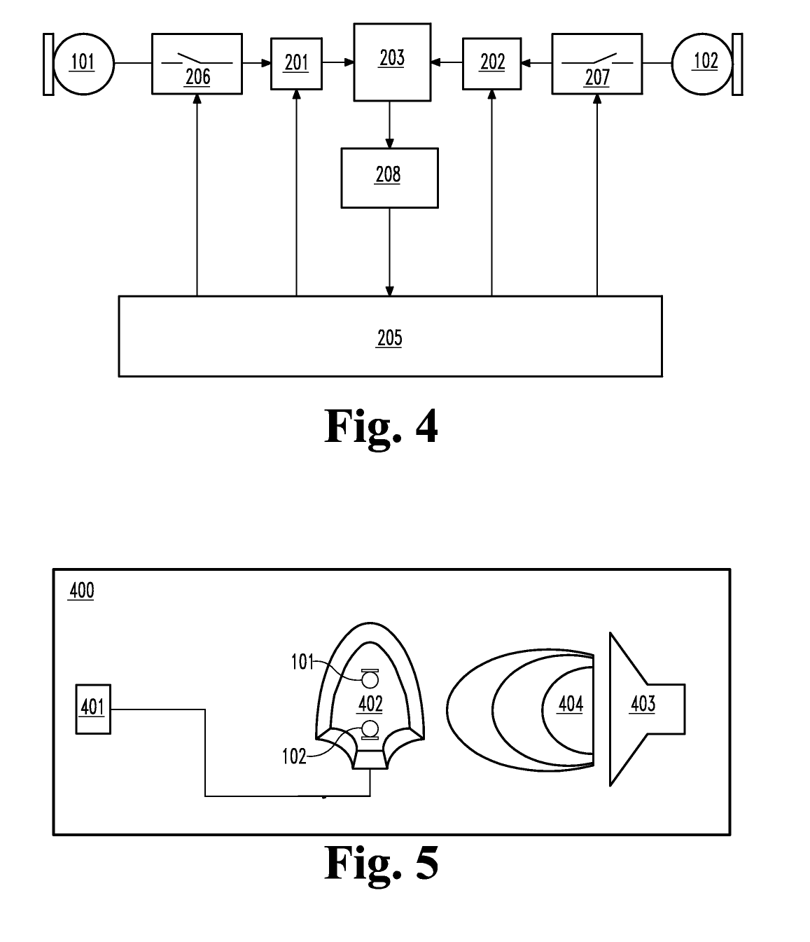

FIG. 4 is a schematic diagram of a microphone with components for automated channel balancing/correction. If no frequency response correction is required, the procedure for channel balancing in this embodiment is as follows:
A uniform acoustical field 404 in the form of white noise (see FIG. 5) is applied to microphone capsules 101 and 102.
Amplifiers 201 and 202 are set to have the same initial fixed gain value.
Microcontroller 205 turns on switch 206 and turns off switch 207 so that only audio coming through microphone capsule 101 is being processed by mixer 203.
Microcontroller 205 reads the output level from capsule 101 from the level detector 208.
Microcontroller 205 turns off switch 206 and turns on switch 207 so that only audio coming through microphone capsule 102 is being processed by mixer 203.
Microcontroller 205 reads the output level from capsule 102, compares it to the output level from the capsule 101, and adjusts the gain value for amplifier 207 until the output level from capsule 102 becomes equal to the one measured with switch 206 on (that is, the output level from capsule 101). In some embodiments, this calibrated gain value is saved permanently (e.g., in a non-volatile memory) for that particular microphone.

If frequency response correction of microphone capsules is required, the procedure is as follows:
An external signal generator creates a sequence of single tones, which are applied to microphone capsules 101 and 102 by the speaker as a uniform acoustical field. Depending on the number of bands necessary, one of the standard sequences (for example, one-third octave bands) can be used. Switching to the next tone in a sequence is controlled by microcontroller 205.
The first frequency of a sequence is applied to microphone capsules 101 and 102.
Microcontroller 205 turns on switch 206 and turns off switch 207 so that only audio coming through microphone capsule 101 is being processed by mixer 203.
A fixed gain is applied to the first band of equalizer 206.
Microcontroller 205 reads the output level from capsule 101 from the level detector 208.
Microcontroller 205 switches the signal generator to the next tone in the sequence and measures the output level of capsule 101.
The output level is compared to the one for the previous tone, and the current band gain is adjusted until the levels are equal.
The procedure of switching to the next tone and adjusting gain is repeated until all tones in the sequence are exhausted.
To achieve better results, the whole procedure may be repeated until repeatable results are achieved.
Microcontroller 205 turns off switch 206 and turns on switch 207 so that only audio coming through microphone capsule 102 is being processed by mixer 203.
Starting from the lowest band, microcontroller 205 measures the output level from capsule 102, compares it to the level from capsule 101 and adjusts the gain for the current band of equalizer 207 until both levels are equal.
Calibration data is stored to restore the gain for each capsule to the adjusted point.
Microcontroller 205 switches the signal generator to the next tone and adjusts gains until the whole tone sequence is exhausted.
To achieve better results, the procedure for capsule 102 may be repeated until repeatable results are achieved.

In some embodiments, the output of mixer 203 is further calibrated as follows:
A uniform acoustical field 404 in the form of white noise (see FIG. 5) is applied to microphone capsules 101 and 102.
Any mixer equalizer gains are set to 0 dB.
An output gain applied to the combined output of the first microphone capsule 101 and second microphone capsule 102 is adjusted until a target output level is achieved.
Calibration data is stored to restore the output gain to the adjusted point.

Similarly, the response of mixer 203 to input of various frequencies is calibrated in some embodiments for each selectable response pattern as follows:
The response pattern for the microphone is set to the selected response pattern.
An external signal generator creates a sequence of single tones, which are applied to microphone capsules 101 and 102 by the speaker as a uniform acoustical field. Depending on the number of bands necessary, one of the standard sequences (for example, one-third octave bands) can be used. Switching to the next tone in a sequence is controlled by microcontroller 205.
The first frequency of a sequence is applied to microphone capsules 101 and 102.
The microphone's mixer output gain is adjusted until a desired reference output level is achieved.
Calibration data is stored to restore the mixer output gain to the adjusted point.
These steps are repeated for each frequency band.

Fast testing of the balancing between microphone capsules 101 and 102 can be achieved by switching the microphone to the figure-eight pattern and applying acoustical field 404 at equal distance from capsules 101 and 102 (see FIG. 5). Switches 206 and 207 are closed (FIG. 4). Microcontroller 205 measures the output signal from the mixer 203 through the level detector 204. If capsules are balanced, the output signal from mixer 203 should be equal to zero with the precision chosen by current application requirements.

For automated channel balancing and testing, microphone 402 may be placed in an anechoic test box 400, as illustrated in FIG. 5. Embedded speaker 403 produces a uniform acoustical field 404 from speaker 403 for application to microphone capsules 101 and 102.

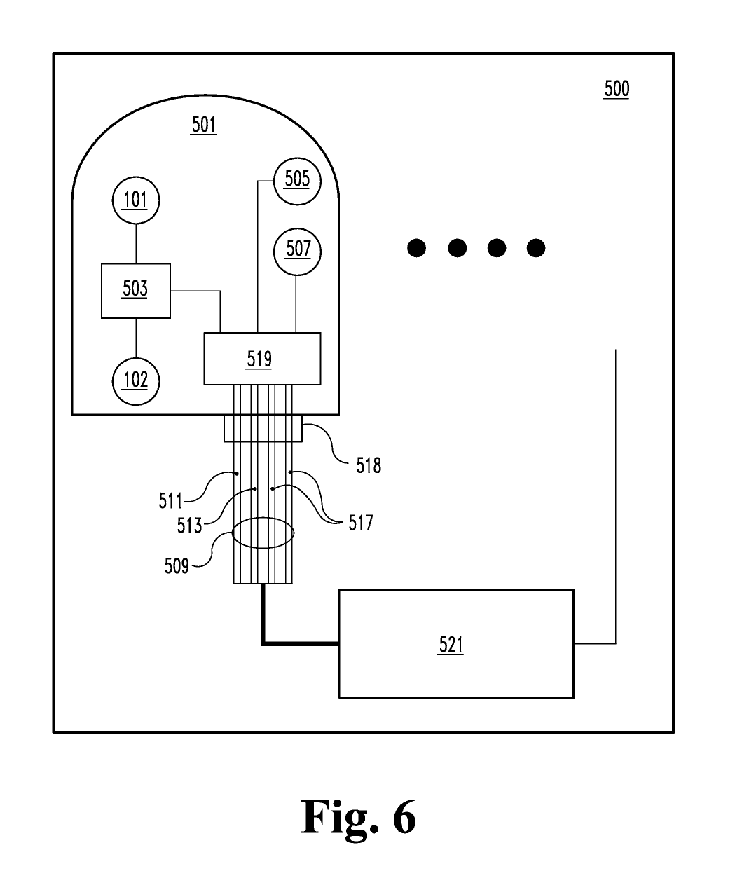

As illustrated schematically in FIG. 6, microphone 501 includes a DSP-based, customizable audio development engine 503 with configurable sensitivity patterns and mute capability; a touch-sensing push button 505; and one or more configurable, multi-color RGB LED indicators 507. The microphone 501 is connected to a host audio system 521 by a CAT-x cable 509 via RJ-45 connector 518, and that cable carries at least the following signals: power 511 to the microphone 501, a differential analog/digital audio signal 513 and a bidirectional serial communication channel 517 (differential).

Push button 505 is configured in this embodiment to generate “button pressed” and “button released” events for the system corresponding to the pressing and releasing of the physical button. As a function of the current “control mode” of microphone 501 (local, remote, or mixed, for example), these events, their timing, and their sequence are interpreted either locally by a microcontroller 519 or by the host audio system 521. Responsive actions taken by the system 500 are based on the interpretation of these events and the current control mode.

RGB LED indicator(s) 507 provide a significant increase in functionality over single-color indicators. Indicator(s) 507 are fully configurable, allowing the system manufacturer, installer, integrator, or the like to create multiple custom light patterns based on combinations of their color, intensity, and timed lighting operation, such a combination for a light element being an “activation state.” Light patterns in some embodiments include one or more of the following:
custom colors shown with a uniform intensity;
blinking of a custom color with a particular pattern; and
a custom color “wave,” for example, by changing the intensity of a single color and/or changing the color over time, such as a gradual transition between two colors.
   Multiple-stage sequences can be configured by combining these light patterns. This variety of signaling techniques greatly increases the available methods that can be applied to communicate information to users of the system.

In some implementations, a particular microphone is assigned a “base” color, which is used with the signaling techniques listed above to create signaling patterns adapted for that particular microphone. The “base” color distinguishes that microphone from other microphones in that particular system for more convenient configuration, use, and management.

Touch button 505 may have various functions depending on the configuration and the microphone's operating mode: local, remote, or mixed.

As mentioned above, microphones in the present embodiment can operate in local, remote, and mixed control modes. In local mode, operation of the microphone 501 is based on a locally stored configuration, which could be either preprogrammed at or uploaded to the microphone (for example, over a serial port (not shown) or communication channel 517). Button 505 events are interpreted locally based on the configuration, which also defines actions to be taken based on button events or sequences thereof. Responsive actions that can be used in some embodiments include:
microphone push-to-mute, push-to-talk, hold-to-mute, hold-to-talk, etc.;
displaying preconfigured light patterns to attract attention;
displaying microphone properties, such as an indicator of the audio pattern currently selected; and
configuring microphone properties, such as the selected audio pattern.
   In local mode, RGB indicator(s) 507 can reflect status or indicate the taking of an action based on a button event, or display microphone status information using configured light patterns, to name just a few options. Though others will occur to those skilled in the art, selected example status information includes:
mute/un-mute status;
input audio level (e.g., by changing color and/or intensity); and
failure, malfunction, or error status of the microphone 501 or broader system 500.

In remote mode, the microphone 501 operates as a function of the configuration stored on the host system 521.
events and commands are communicated over the serial channel 517;
the host system 521 can query the status of push button 505 at any time;
local microphone properties, such as an audio pattern such as the currently selected audio sensitivity pattern, can be queried or changed at any time by sending a command from the host 521 to the microphone 501;
the firmware in microphone 501 can be updated by the host 521 over the serial communication channel 517;
button events are sent to the host system 521 and interpreted by the host system 521, such as
   audio functions, such as push-to-mute, push-to-talk, hold-to-mute, hold-to-talk, etc., and
   system functions, such as record, private, request to talk, request for attention, etc., where custom configuration allows adjusting system functions for particular use scenarios; and
operation of the LED indicator 507 is defined by a light pattern command sent from the host 521. In this mode, indicator 507 can display the local and/or system status, as defined by the command, such as:
   microphone mute/unmute,
   system record, private status, etc.,
   permission/request to talk,
   system error or malfunction code,
   microphone connection error code,
   microphone identity, and
   other functions defined by the system.

Mixed mode is a combination of local and remote modes, wherein operation of the microphone's audio engine 503, the effect of push button 505, and output of indicator(s) 507 can be defined by local configuration, host commands, or a combination of the two. This mode is the most flexible and allows customization of the microphone's operation for various use scenarios.

All publications, prior applications, and other documents cited herein are hereby incorporated by reference in their entirety as if each had been individually incorporated by reference and fully set forth. While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. A system, comprising:
a microphone array comprising a first microphone capsule and a second microphone capsule, the first and second microphone capsules being in a substantially fixed position relative to each other, and the array having two or more polar response patterns; and
a digital signal processor having an automatically adjustable gain structure and configured to combine an output of each microphone capsule to produce a sound output signal;
wherein, when the polar response pattern of the microphone array changes, the digital signal processor automatically adjusts the gain structure to compensate for the differences between the response patterns before and after the change.

2. The system of claim 1, wherein the automatic adjustment of the gain structure is performed as a function of calibration data, the system further comprising a processor and a memory in communication with the processor, the memory encoded with programming instructions executable by the processor to sequentially:
apply a uniform acoustic field to the microphone array in the form of white noise;
ignore the output of the first microphone capsule and measure a level of the output of the second microphone capsule;
ignore the output of the second microphone capsule and measure a level of the output of the first microphone capsule;
adjust the balance between the first microphone capsule and the second microphone capsule in the sound output signal; and
store the calibration data that indicates the balance between the first microphone capsule and the second microphone capsule.

3. The system of claim 1, wherein the automatic adjustment of the gain structure is performed as a function of calibration data, the system further comprising a processor and a memory in communication with the processor, the memory encoded with programming instructions executable by the processor to perform frequency calibration including, for each of a plurality of frequency bands:
applying to the microphone array a uniform acoustic field comprising a sound within the frequency band;
ignoring the output of the second microphone capsule, adjusting a first capsule equalizer gain applied to the output of the first microphone capsule until a first target level is reached;
ignoring the output of the first microphone capsule, adjusting a second capsule equalizer gain applied to the output of the second microphone capsule until a second target level is reached;
storing information sufficient to restore the first gain and the second gain.

4. The system of claim 3, wherein the first target level is constant across the plurality of frequency bands.

5. The system of claim 3, wherein the second target level is equal to the first target level.

6. The system of claim 1, wherein:
the digital signal processor comprises a mixer and an independent gain structure setting for the first and second microphone capsules; and
adjusting the balance between the first microphone capsule and the second microphone capsule comprises changing one or more of the independent gain structure settings.

7. The system of claim 6, wherein the independent gain structure setting for each microphone capsule comprises a plurality of gain settings, each associated with a particular frequency band.

8. The system of claim 6, further comprising a processor and a memory in communication with the processor, the memory encoded with programming instructions executable by the processor to:
apply to the microphone array a uniform acoustic field in the form of white noise;
set any mixer equalizer gains to 0 dB; and
adjust an output gain applied to the combined output of the first microphone capsule and second microphone capsule until a target output level is achieved.

9. The system of claim 1, wherein the automatic adjustment of the gain structure is performed as a function of calibration data, the system further comprising a processor and a memory in communication with the processor, the memory encoded with programming instructions executable by the processor to perform frequency-based calibration including, for each of the plurality of polar response patterns:
setting the microphone array to use the particular polar response pattern;
applying to the first microphone capsule and the second microphone capsule a uniform acoustic field comprising a sound within the frequency band;
adjusting a mixer equalizer gain applied to the combined output of the first microphone capsule and the second microphone capsule until a reference output level is achieved;
storing as at least a portion of the calibration data information sufficient to restore the output gain setting.

10. A microphone system comprising a microphone capsule, a processor, a memory in communication with the processor, and one or more multi-colored lights in a common housing with the microphone capsule, each light having a plurality of programmatically selectable activation states,
wherein the memory is encoded with programming instructions executable by the processor to change the activation state of at least one of the one or more multi-colored lights as a function of an operational characteristic of the microphone system.

11. The system of claim 10, wherein the operational characteristic is selected from the set consisting of a system power status, failure mode, recording status, microphone identification, system connection status, and microphone sensitivity pattern.

12. The system of claim 10, wherein each activation state is selected from the set consisting of color selection, flashing pattern, pulsing pattern, fading pattern, and progression between two or more colors.

13. The system of claim 10, wherein
the operational characteristic is an input level detected by the microphone, and
the activation state is selected from a range as a function of the input level.

14. The system of claim 13, where the activation state is a brightness level of the lights.

15. The system of claim 13, where the activation state is a color of the lights.

16. The system of claim 10, wherein the processor and memory are in the housing.

17. A system comprising:
a microphone having a connector;
a cable having a first end, a second end, and multiple conductors running therebetween, the first end being attached to the connector, the second end being connected to a device, and the multiple conductors collectively carrying
power to the microphone from the device,
one or more audio output signals from the microphone to the device,
first communication data from the microphone to the device, and
second communication data from the device to the microphone.

18. The system of claim 17, wherein the connector is an RJ-45 connector.

19. The system of claim 17, wherein the one or more audio output signals comprise differential analog audio.

20. The system of claim 17, wherein the one or more audio output signals comprise digital audio.

21. The system of claim 17, wherein the cable is selected from category 5, category 5e, and category 6 cable.

22. The system of claim 17, wherein the device comprises a processor and memory in communication with the processor, the memory being encoded with programming instructions executable by the processor to process the one or more audio output signals, perform system-level function, and send the second communication data to the microphone.

23. The system of claim 17, wherein the data is communicated serially from the device to the microphone.

24. The system of claim 17,
further comprising a pushbutton in a common housing with the microphone and the connector;
wherein the pushbutton is configured to trigger operation of a previously determined function at one or both of the microphone and the device.
